(19) United States
(12) Patent Application Publication
(10) Pub. No.: US 2005/0285883 A1
(43) Pub. Date: Dec. 29, 2005

(54) Method for determining digital video signal of digital display

(75) Inventor: Feng-Lin Chen, Tucheng City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/168,170

(22) Filed: Jun. 28, 2005

(30) Foreign Application Priority Data
Jun. 29, 2004 (TW) 93119159

(51) Int. Cl. G09G 3/30; G09G 5/02

(52) U.S. Cl. 345/698; 345/76

(57) ABSTRACT

A method for determining a digital signal of a digital display is provided. An extended display identification data (EDID) of the display is read by a computer via a display data (DDC) bus. Firstly, a predetermined parameter is outputted from the computer via the DDC when a user utilizes the computer to reset the resolution of the display. Then, the predetermined parameter is received and saved by the digital display. A horizontal synchronization signal, a vertical synchronization signal and an analog video signal outputted from the computer are received and saved by the digital display. an actual parameter is calculated by the digital display according to the horizontal synchronization signal and the vertical synchronization signal. Lastly, the digital video signal is determined by the digital display according to the predetermined parameter and the actual parameter.

This application claims the benefit of Taiwan application Serial No. 93119159, filed Jun. 29, 2004, the subject matter of which is incorporated herein by reference.

### BACKGROUND OF THE INVENTION

1. Field of the Invention

The invention relates in general to a method for determining the digital video signal of a digital display whose input interface is an analog signal, and more particularly to a method for determining the digital video signal of a digital display from analog video signals according to predetermined parameters and actual parameters.

2. Description of the Related Art

With the rapid advance in science and, technology, display has become an indispensable appliance to modern people who live in a time. A display comprises a cathode ray tube (CRT) monitor and a digital display. The CRT monitor is an analog display while the digital display comprises a liquid crystal display (LCD) and an organic light emitting diode (OLED) display. The digital display, with the exclusive features of slimness, compactness, light weight, low radiation and tender frame that the CRT monitor lack of, has gradually replaced the CRT monitor and become the most popular computer monitor to modern people.

When a computer is turned on or activated to identify the coupled digital display thereof, the computer reads an extended display identification data (EDID) of the digital display via a display data channel (DDC) bus to identify the model and display specification of the digital display. Currently, there are two types of output video signal interfaces of the display card, namely, Dsub and DVI, wherein the Dsub is an analog interface, while the DVI is a digital interface. The computer outputs a vertical synchronization signal, a horizontal synchronization signal and an analog RGB video signal to the digital display via the Dsub, wherein the digital display converts the analog RGB video signal into the digital RGB video signal according to the vertical synchronization signal and the horizontal synchronization signal, so that a corresponding frame is displayed on the digital display.

Referring to FIG. 1A, a flowchart of conventional method for determining the digital video signal of the digital display is shown. In step 11, when the user resets the resolution of the digital display to be 640×400, the computer detects that the resolution of the digital display would be reset, and the display card accordingly outputs a corresponding horizontal synchronization signal (Hsync), a vertical synchronization signal (Vsync) and an analog RGB video signal to the digital display as shown in FIGS. 1B˜1C. A 640×400 resolution outputted to the digital display by the display card means that the number of the display pixels per horizontal line (Hdisplay) is 640 and that the number of the display pixels per horizontal line (Vdisplay) displayed by the digital display is 400. In FIG. 1C, W stands for the horizontal synchronization width (Hsync width), F stands for the size of the horizontal front porch (H front porch), B stands for the size of the horizontal back porch (H back porch), wherein the sum of W, F and B is a blanking time.

Next, in step 12, the digital display receives, calculates and saves the horizontal synchronization signal, the vertical synchronization signal and the analog RGB video signal. Then, in step 13, the digital display has a timing table whence the digital display looks up a total number of the pixels in each horizontal line (Htotal) according to the horizontal synchronization signal and the vertical synchronization signal. Suppose the total number of the pixels in each horizontal line is 900, the digital display would map a T segment of the analog RGB video signal to the 900 pixels of the horizontal line unit, and the analog to digital converter (ADC) of the digital display would sample 900 pixels from each horizontal line to be the corresponding video image of the T segment of the analog RGB video signal. Next, in step 14, the digital display obtains a phase lock loop (PLL) sampling signal according to the total number of the pixels in each horizontal line and the horizontal synchronization signal. Lastly, in step 15, the digital display samples a D segment of the analog RGB video signal to obtain a displayed RGB video signal according to the PLL sampling signal.

More and more display drivers and user interface application programs provided by display card manufacturers allow the user to adjust resolutions. When a digital display fails to locate a corresponding time sequence from a number of built-in timing tables, the digital display would locate an approximate time sequence from the timing tables and select a total number of the pixels in each horizontal line contained in the time sequence. The PLL sampling signal obtained by the digital display according to the approximate total number of the pixels in each horizontal line and the frequency of the horizontal synchronization signal would not match with or even would differ widely with the correct total number of the pixels in each horizontal line. Consequently, the digital display would sample the D segment of the analog RGB video signal to obtain an erroneous digital RGB video signal according to the erroneous PLL sampling signal, largely affecting the display quality of the digital display.

Besides, the digital display would display 640 display pixels on each horizontal line after having received an analog calibration signal when the resolution of the digital display is 640×400. When the digital display receives a non-full-frame analog RGB video signal, the digital display would respectively sample two dots from the left and the fight side of the 640 dots as black spots (in terms of 8 bits, the gray level value is 0), furthermore, the four sampled black spots correspond to the non-full-frame analog RGB video signal. That is to say, the digital display should display the four black spots. However, the digital display eradicates two black spots from both the left side and the right side of the 640 dots, and then uses a heterodyne method or a numeric method to compensate the missing dots. By doing so, the size of the horizontal front porch and the size of the horizontal back porch would be increased and the digital display would display an erroneous frame.

Besides, it is possible that the same vertical polarity and frequency as well as the same horizontal polarity and frequency may have the same vertical synchronization signal and the horizontal synchronization signal but have different resolutions. Take the 31.47 KHz (−)/70 Hz (+) for example. There are two types of resolutions: 640×400 and 720×400. When 31.47 KHz is a horizontal frequency with negative polarity, the display card would output 31.47K horizontal lines per second. When 70 Hz is a vertical frequency whose polarity is positive, the display card can update 70 frames per second. When the user uses the computer to reset the resolution of the digital display to be 640×400, the digital display would choose one from the two resolutions, and an erroneous frame whose resolution is 720×400 would occur under such circumstances. This is because the digital display is only able to look up a total number of the pixels in each horizontal line from the in-built timing table according to the vertical synchronization signal and the horizontal synchronization signal, but is unable to determine whether each horizontal line should comprises 640 or 720 display pixels.

### SUMMARY OF THE INVENTION

The object of the invention is to provide a method for determining the digital video signal of a digital display whose input interface is analog. The design of receiving the predetermined parameter outputted from the computer before the actual number of the pixels per horizontal line is determined by the digital display allows the digital display to promptly and correctly determines the actual total number of the pixels in each horizontal line, largely providing flexibility for the user to adjust the resolution of the digital display as desired. By doing so, the clock sampling frequency, which is obtained by the display according to the horizontal synchronization signal and the actual number of the pixels per horizontal line, is correct and is used to sample an analog video signal accordingly. Besides, the correct predetermined parameter, which is outputted from the computer and received by the display, enables the clock sampling signal to sample the analog video signals to obtain a correct digital display signal according to the size of the horizontal front porch, the size of the horizontal back porch and the number of the display pixels in each horizontal line.

It is therefore an object of the invention to provide a method for determining a digital signal of a digital display. An extended display identification data (EDID) of the display is read by a computer via a display data (DDC) bus. The method includes the following steps. At first, at least one predetermined parameter is outputted from the computer to the digital display via the DDC when a user utilizes the computer to reset the resolution level of the digital display. Then, the predetermined parameter is received and saved by the digital display. A horizontal synchronization signal, a vertical synchronization signal and an analog video signal outputted from the computer are received and saved by the digital display. At least one actual parameter is calculated by the digital display according to the horizontal synchronization signal and the vertical synchronization signal. Lastly, the digital video signal is determined from the analog video signal by the digital display according to the predetermined parameter and the actual parameter.

It is therefore another object of the invention to provide a method for determining a digital signal of a digital display. An EDID of the digital display is read by a computer via a DDC bus. The method includes the following steps. At first, at least a predetermined parameter is outputted from the computer to the digital display via the DDC bus when the computer detects that the resolution of the digital display is reset by user. Next, the predetermined parameter is received and saved by the digital display. Then, an analog video signal is outputted to the digital display from the computer. Next, the analog video signal digital display is received and saved by the digital display. Lastly, a digital video signal is determined from the analog video signal by the digital display according to the predetermined parameter.

It is still another object of the invention to provide a method for determining a total number of the pixels in each horizontal line of the digital display. An EDID of the digital display is read by a computer via a DDC bus. The method includes the following steps. At first, at least a predetermined parameter is outputted from the computer to the digital display via the DDC bus when the computer detects that the resolution of the digital display is reset by a user. Next, the predetermined parameter is received and saved by the digital display. Then, a horizontal synchronization signal, a vertical synchronization signal and an analog video signal are outputted to the digital display from the computer. Next, the horizontal synchronization signal, the vertical synchronization signal and the analog video signal digital display are received and saved by the digital display. After that, at least one actual parameter is calculated by the digital display according to the horizontal synchronization signal and the vertical synchronization signal. Lastly, the total number of the pixels in each horizontal line is determined by the digital display according to the predetermined parameter and the actual parameter.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A (Prior Art) is a flowchart of conventional method for determining the digital video signal of the digital display;

FIG. 1B (Prior Art) is a wave diagram of the vertical synchronization signal and the horizontal synchronization signal;

FIG. 1C (Prior Art) is a wave diagram of the vertical synchronization signal and the analog RGB video signal;

FIG. 2 is a flowchart of the method for determining the digital video signal of a digital display according to a first embodiment of the invention;

FIG. 3 is a flowchart of the step of detecting parameter transmission of FIG. 2;

FIG. 4 is a flowchart showing how the digital display of FIG. 2 determines the digital video signal from the analog video signal according to the predetermined parameter and the actual parameter;

FIG. 5 is a flowchart showing how the digital display of FIG. 4 determines actual total number of the pixels in each horizontal line;

FIG. 6 is a flowchart of the method for determining the digital video signal of a digital display according to a second embodiment of the invention; and

FIG. 7 is a flowchart showing how the digital display of FIG. 6 determines the digital video signal from the analog video signal according to predetermined parameter.

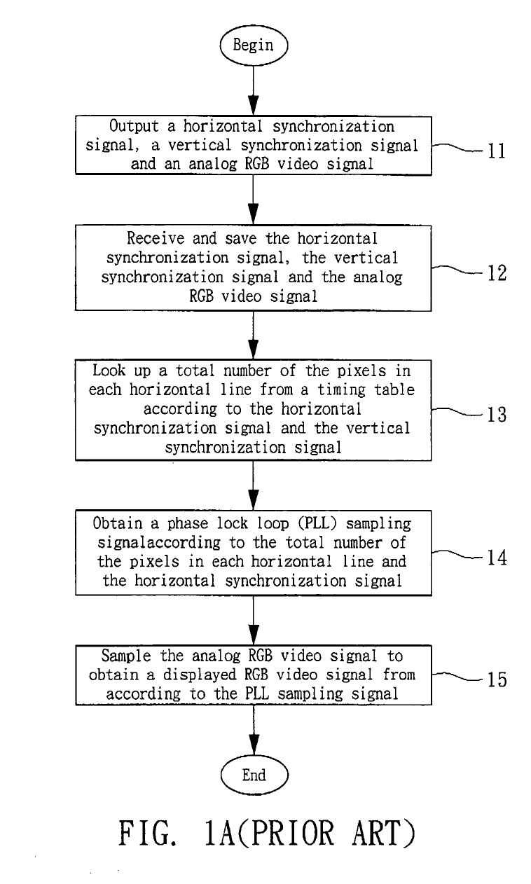

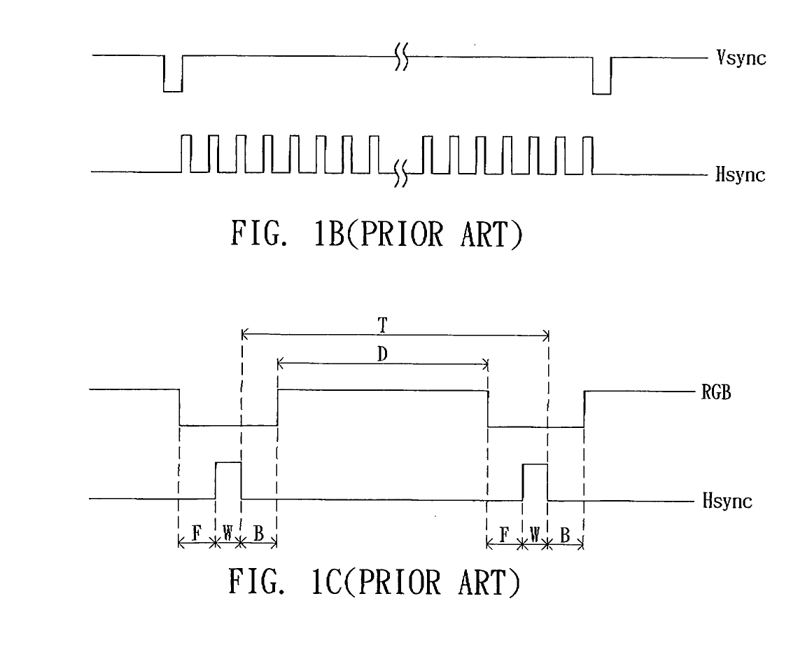

### DETAILED DESCRIPTION OF THE INVENTION

### First Embodiment

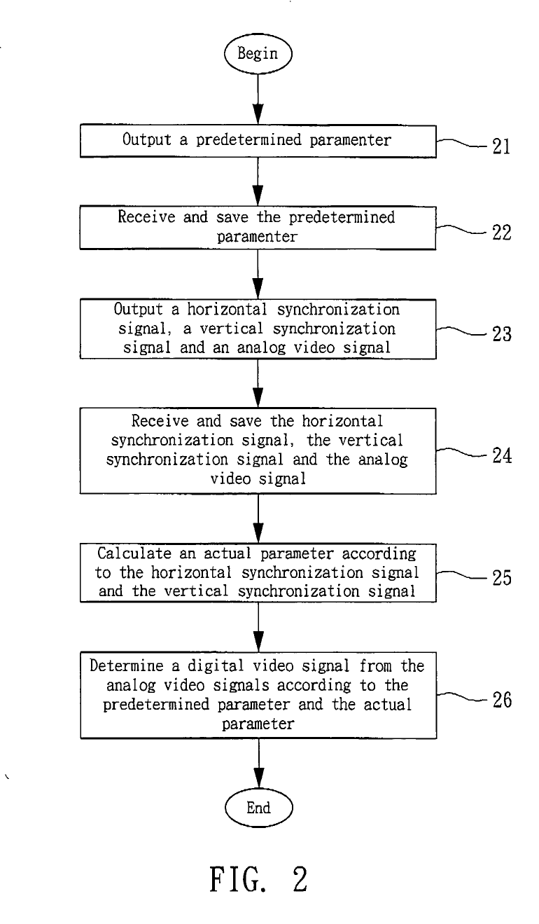

Referring to FIG. 2, a flowchart of the method for determining the digital video signal of a digital display according to a first embodiment of the invention is shown. The digital display is coupled with a computer. When the computer is turned on or activated to identify the model and display specification of the digital display, the computer reads an extended display identification data (EDID) of the digital display via a display data channel (DDC) bus. The method begins at step 21: when the user changes the resolution of the digital display, the computer detects that the resolution of the digital display is going to be updatedand outputs at least a predetermined parameter to the digital display via the DDC bus. The predetermined parameter comprises a predetermined vertical frequency, a predetermined vertical polarity, a predetermined horizontal frequency, a predetermined horizontal polarity, a predetermined total number of the horizontal lines in each frame (V total), a predetermined total number of the pixels in each horizontal line (H total), a predetermined total number of the display pixels in each horizontal line (H display), a predetermined size of the horizontal front porch (H front porch) and a predetermined size of the horizontal back porch (H back porch) and so forth. Besides, the predetermined horizontal frequency means the predetermined total number of the horizontal lines displayed by the digital display per second, and the predetermined vertical frequency means the predetermined total number of frames displayed by the digital display per second. Furthermore, the predetermined total number of the horizontal lines in each frame means the predetermined total number of the horizontal lines displayed by digital display per frame, the predetermined total number of the pixels in each horizontal line means the predetermined total number of the display pixels by the digital display per horizontal line, and the predetermined total number of the display pixels in each horizontal line means the predetermined total number of the display pixels displayed by the digital display per horizontal line.

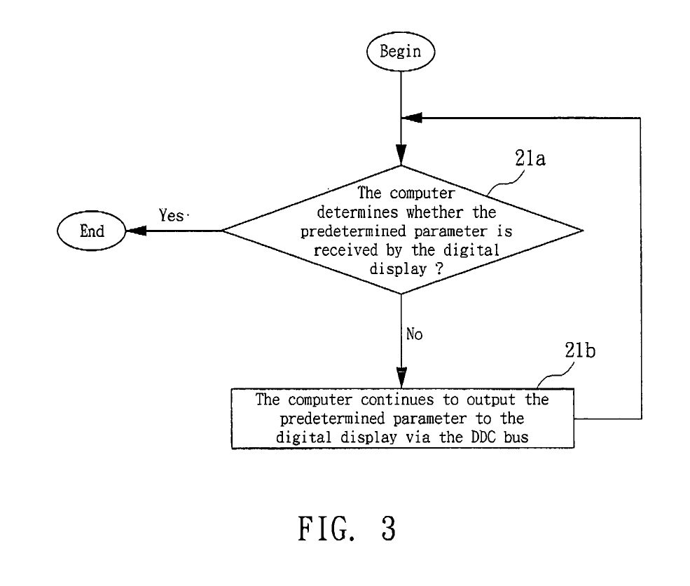

In step 21, the present embodiment further comprises a step of detecting parameter transmission to assure that the predetermined parameter is received by the digital display as shown in FIG. 3. In step 21a, the computer determines whether the predetermined parameter has been received by the digital display: if so, terminate the step of detecting parameter transmission and in step 22 of FIG. 2, otherwise in step 21b, the computer continues to output the predetermined parameter to the digital display via the DDC bus, and then return to step 21a.

In step 22, the predetermined parameter is received and saved by the digital display, wherein the digital display can label the predetermined parameter saved therein as a newest flag parameter, signifying that the predetermined parameter has been received by digital display.

After the computer confirms that the predetermined parameter has been received by the digital display, in step 23, the display card outputs a horizontal synchronization signal (Hsync), a vertical synchronization signal (Vsync) and an analog video signal to the digital display, wherein the analog video signal can be an analog RGB video signal for instance. Next, in step 24, the digital display receives and saves the horizontal synchronization signal, the vertical synchronization signal and the analog video signal. Then, in step 25, at least one actual parameter is calculated by the digital display according to the horizontal synchronization signal and the vertical synchronization signal. The actual parameter comprises an actual vertical frequency, an actual vertical polarity, an actual horizontal frequency, an actual horizontal polarity and an actual total number of the horizontal lines in each frame and so forth. Besides, the actual horizontal frequency means the actual total number of the horizontal lines scanned by the digital display per second, the actual vertical frequency means the actual total number of frames updated by the digital display per second, the actual total number of the horizontal lines in each frame means the actual total number of the horizontal lines that the digital display must have per frame.

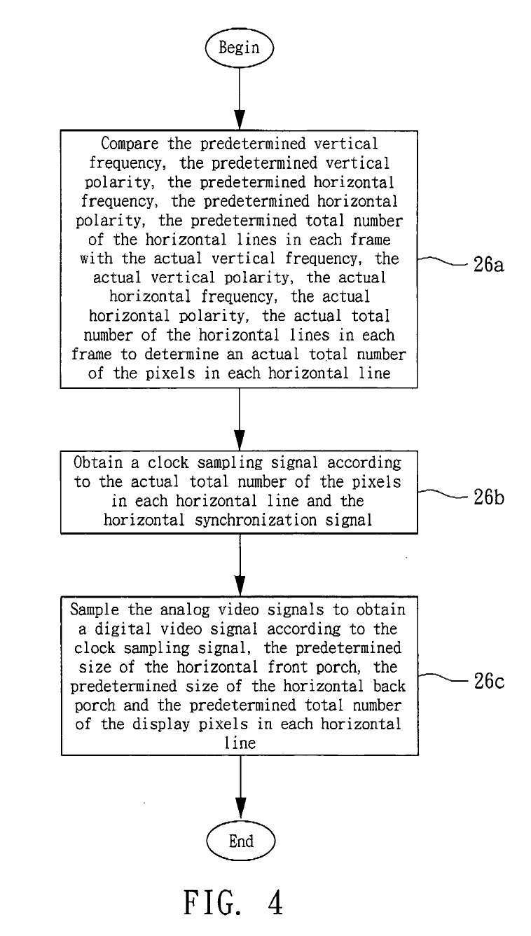

Next, in step 26, the digital display determines a digital video signal from the analog video signals, such as a digital RGB video signal for instance, according to the predetermined parameter and the actual parameter. In the present embodiment, the digital display determines the digital video signal from the analog video signals as shown in FIG. 4. Step 26 begins at step 26a: After saving the predetermined parameter or the newest flag parameter, the digital display compares the predetermined vertical frequency, the predetermined vertical polarity, the predetermined horizontal frequency, the predetermined horizontal polarity, the predetermined total number of the horizontal lines in each frame with the actual vertical frequency, the actual vertical polarity, the actual horizontal frequency, the actual horizontal polarity, the actual total number of the horizontal lines in each frame to determine an actual total number of the pixels in each horizontal line.

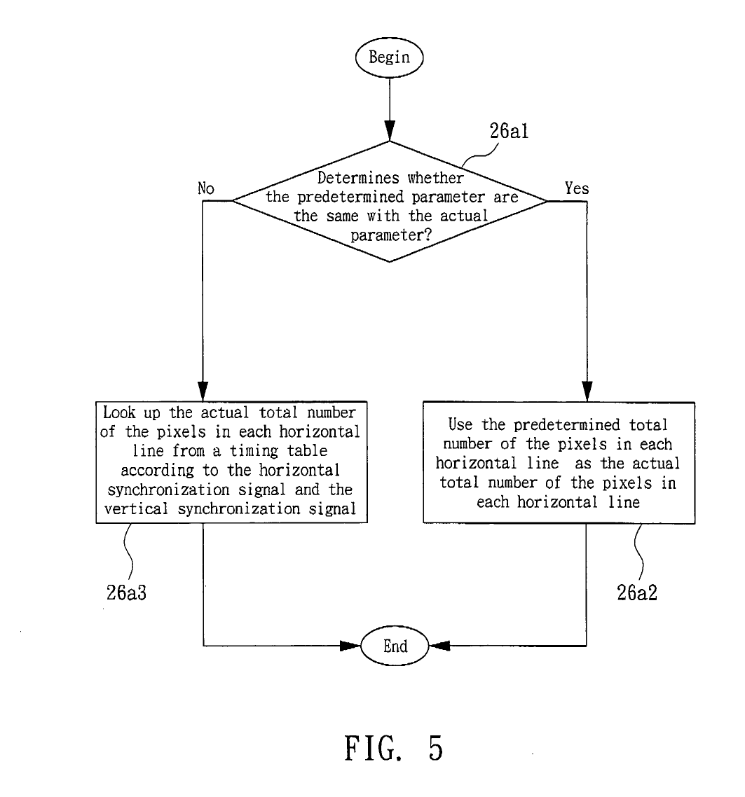

In step 26a, the present embodiment further comprises a step of determining the actual total number of the pixels in each horizontal line as shown in FIG. 5. At first, in step 26a1, the digital display determines whether the predetermined vertical frequency, the predetermined vertical polarity, the predetermined horizontal frequency, the predetermined horizontal polarity and the predetermined total number of the horizontal lines in each frame are the same with the actual vertical frequency, the actual vertical polarity, the actual horizontal frequency, the actual horizontal polarity and the actual total number of the horizontal lines in each frame. If so, in step 26a2, the digital display uses the predetermined total number of the pixels in each horizontal line saved therein as the actual total number of the pixels in each horizontal line. If the above predetermined parameters differ with the above actual parameters, in step 26a3: the digital display looks up one value in the timing table as the the corresponding actual total number of the pixels in each horizontal line according to the horizontal synchronization signal and the vertical synchronization signal.

It can be seen from the above disclosure that the steps 21˜26 can be called a method for determining the actual total number of the pixels in each horizontal line. The digital display only need to receive and save the predetermined vertical frequency, the predetermined vertical polarity, the predetermined horizontal frequency, the predetermined horizontal polarity and the predetermined total number of the horizontal lines in each frame to determine the actual total number of the pixels in each horizontal line.

After the digital display has determined the actual total number of the pixels in each horizontal line, step 26b of FIG. 4 is proceeded. In step 26b, the digital display obtains a clock sampling signal, such as a phase lock loop (PLL) sampling signal for instance, according to the actual total number of the pixels in each horizontal line and the horizontal synchronization signal. Next, in step 26c, the digital display samples the analog video signals to obtain a digital video signal according to the clock sampling signal, the predetermined size of the horizontal front porch, the predetermined size of the horizontal back porch and the predetermined total number of the display pixels in each horizontal line.

Being capable of receiving the predetermined parameter outputted from the computer, the digital display can promptly and correctly determine the actual total number of the pixels in each horizontal line, providing flexibility for the user to adjust the resolution of the digital display as desired. By doing so, the clock sampling frequency, which is obtained by the display according to the horizontal synchronization signal and the actual number of the pixels per horizontal line, is also correct. Besides, the correct predetermined parameter, which is outputted from the computer and received by the display, enables the clock sampling signal to sample the analog video signals to obtain a correct digital display signal according to the size of the horizontal front porch, the size of the horizontal back porch and the number of the display pixels in each horizontal line.

For example, the digital display would display 640 display pixels on each horizontal line after having received an analog calibration signal when the resolution of the digital display is 640×400. When the digital display receives a non-full-frame analog RGB video signal, the digital display would respectively sample two dots from the left and the fight side of the 640 dots as black spots (in terms of 8 bits, the gray level value is 0), furthermore, the four black spots correspond to the non-full-frame analog RGB video signal. That is to say, the digital display should display the four sampled black spots. Since the digital display has saved the predetermined size of the horizontal front porch and the predetermined size of the horizontal back porch, the digital display will display the pixels of the original 640 dots without eradicating any of the four black spots from the left and the right sides of the 640 dots. By doing so, the digital display will determine a correct digital video signal and display a correct frame.

Besides, take 31.47 KHz (−)/70 Hz (+) for example, there are two types of resolutions: 640×400 and 720×400. When the user uses a computer to set the resolution of the digital display at 640×400, the digital display only display a correct frame with 640×400 resolution not an erroneous frame with 720×400 resolution. This is because the digital display has the number of the display pixels in each horizontal line saved therein and can only have 640 display pixels, not 720, on each horizontal line.

### Second Embodiment

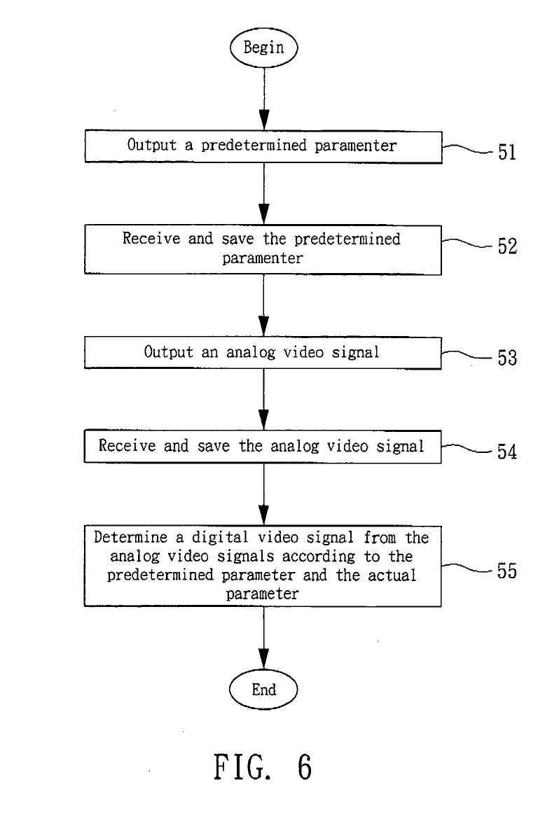

Referring to FIG. 6, a flowchart of the method for determining the digital video signal of a digital display according to a second embodiment of the invention is shown. At first, in step 51, when the user resets the resolution of the digital display, the computer detects that the resolution of the digital display would be reset and outputs at least a predetermined parameter to the digital display via the DDC bus. The predetermined parameter comprises a predetermined vertical frequency, a predetermined vertical polarity, a predetermined horizontal frequency, a predetermined horizontal polarity, a predetermined total number of the horizontal lines in each frame, a predetermined total number of the pixels in each horizontal line, a predetermined total number of the display pixels in each horizontal line, a predetermined size of the horizontal front porch and a predetermined size of the horizontal back porch and so forth.

In step 51, the present embodiment further comprises a step of detecting parameter transmission disclosed below. At first, the computer determines whether the predetermined parameter has been received by the digital display. If so, terminate the step of detecting parameter transmission and in step 52 of FIG. 6, otherwise the computer continues to output the predetermined parameter to the digital display via DDC bus.

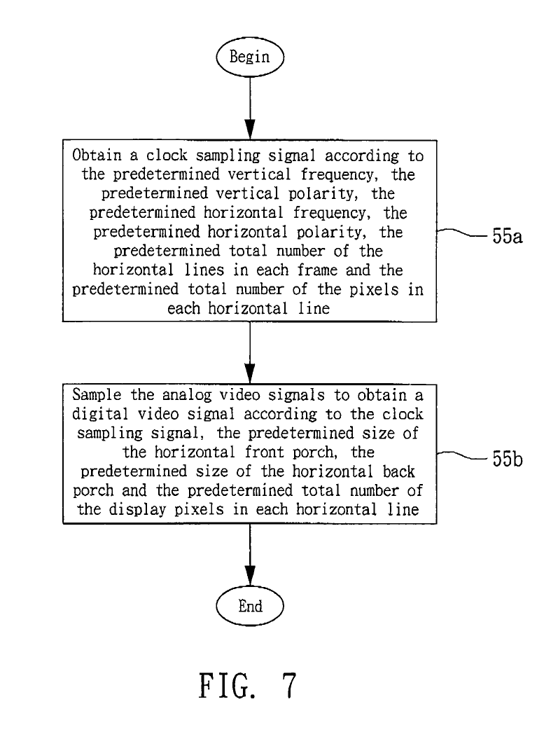

In step 52: the predetermined parameter is received and saved by the digital display, besides, the digital display can label the predetermined parameter saved therein as a newest flag parameter. After the computer confirms that the predetermined parameter has been received by the digital display, step 53 is proceeded. In step 53, the computer outputs an analog video signal to the digital display, wherein the analog video signal can be an analog RGB video signal for instance. Next, in step 54, the analog video signal is received and saved by the digital display. Then, in step 55: the digital display determines a digital video signal from the analog video signal according to the predetermined parameter. In the present embodiment, the digital display determines the digital video signal from the analog video signal as shown in FIG. 7. In step 55a, the digital display, after the predetermined parameter or the newest flag parameter is saved therein, digital display obtains a clock sampling signal, such as a PLL sampling signal for instance, according to the predetermined vertical frequency, the predetermined vertical polarity, the predetermined horizontal frequency, the predetermined horizontal polarity, the predetermined total number of the horizontal lines in each frame and the predetermined total number of the pixels in each horizontal line received thereby. In the first embodiment, the digital display calculates the actual vertical frequency, the actual vertical polarity, the actual horizontal frequency, the actual horizontal polarity and the actual total number of the horizontal lines in each frame according to the vertical synchronization signal and the vertical horizontal signal. Similarly, in the present embodiment, the digital display obtains a vertical synchronization signal and a horizontal synchronization signal according to the predetermined vertical frequency, the predetermined vertical polarity, the predetermined horizontal frequency, the predetermined horizontal polarity and the predetermined total number of the horizontal lines in each frame. Furthermore, the digital display obtains a clock sampling signal according to the vertical synchronization signal and the predetermined total number of the pixels in each horizontal line. After the clock sampling signal is obtained by the digital display, step 55b is proceeded. In step 55b, the digital display samples the analog video signals to obtain a digital video signal according to the clock sampling signal, the predetermined size of the horizontal front porch, the predetermined size of the horizontal back porch and the predetermined total number of the display pixels in each horizontal line.

According to the above embodiments of the invention, the method for determining the digital video signal of a digital display whose input interface is analog has the design of receiving a predetermined parameter outputted from the computer before the actual number of the pixels per horizontal line is determined by the digital display allows the digital display to promptly and correctly determine the actual total number of the pixels in each horizontal line, largely providing flexibility for the user to adjust the resolution of the digital display as desired. By doing so, the clock sampling frequency obtained by the display according to the horizontal synchronization signal and the actual number of the pixels per horizontal line is also correct and is used to sample an analog video signal. Besides, the display enables the clock sampling signal to sample the analog video signals to obtain a correct digital display signal according to the horizontal front porch, the horizontal back porch and the number of the display pixels in each horizontal line.

While the invention is described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation to encompass all such modifications and similar arrangements and procedures.

1. A method for determining a digital video signal output from an analog interface of a digital display, wherein an extended display identification data (EDID) of the digital display is read by a computer via a display data channel (DDC) bus, and the method comprises:
outputting at least a predetermined parameter to the digital display from the computer via the DDC bus when the computer detects that the resolution of the digital display is updated;
receiving and saving the predetermined parameter by the digital display;
outputting a horizontal synchronization signal, a vertical synchronization signal and an analog video signal to the digital display from the computer;
receiving and saving the horizontal synchronization signal, the vertical synchronization signal and the analog video signal by the digital display;
calculating at least one actual parameter by the digital display according to the horizontal synchronization signal and the vertical synchronization signal; and
determining the digital video signal from the analog video signal according to the predetermined parameter and the actual parameter.

2. The method according to claim 1, wherein the predetermined parameter comprises a predetermined vertical frequency, a predetermined vertical polarity, a predetermined horizontal frequency, a predetermined horizontal polarity, a predetermined total number of the horizontal lines in each frame, a predetermined total number of the pixels in each horizontal line, a predetermined total number of the display pixels in each horizontal line, a predetermined size of the horizontal front porch and a predetermined size of the horizontal back porch.

3. The method according to claim 2, wherein the actual parameter comprises an actual vertical frequency, an actual vertical polarity, an actual horizontal frequency, an actual horizontal polarity and an actual total number of the horizontal lines in each frame.

4. The method according to claim 3, wherein the step of determining the digital video signal further comprises:
comparing the predetermined vertical frequency, the predetermined vertical polarity, the predetermined horizontal frequency, the predetermined horizontal polarity, the predetermined total number of the horizontal lines in each frame with the actual vertical frequency, the actual vertical polarity, the actual horizontal frequency, the actual horizontal polarity, the actual total number of the horizontal lines in each frame by the digital display to determine an actual total number of the pixels in each horizontal line;
obtaining a clock sampling signal according to the actual total number of the pixels in each horizontal line and the horizontal synchronization signal; and
Obtaining the digital video signal by sampling the analog video signal according to the clock sampling signal, the predetermined size of the horizontal front porch, the predetermined size of the horizontal back porch and the predetermined total number of the display pixels in each horizontal line.

5. The method according to claim 4, wherein the step of determining the actual total number of the pixels in each horizontal line further comprises:
adopting the predetermined total number of the pixels in each horizontal line as the actual total number of the pixels in each horizontal line when the predetermined vertical frequency, the predetermined vertical polarity, the predetermined horizontal frequency, the predetermined horizontal polarity, the predetermined total number of the horizontal lines in each frame are the same with the actual vertical frequency, the actual vertical polarity, the actual horizontal frequency, the actual horizontal polarity, the actual total number of the horizontal lines in each frame respectively.

6. The method according to claim 4, the digital display having at least a timing table, wherein the step of determining the actual total number of the pixels in each horizontal line further comprises:
looking up one value in the timing table as the total number of the pixels in each horizontal line, wherein the value complies with or approximates the actual total number of the pixels in each horizontal line, according to the horizontal synchronization signal and the vertical synchronization signal when the predetermined vertical frequency, the predetermined vertical polarity, the predetermined horizontal frequency, the predetermined horizontal polarity, the predetermined total number of the horizontal lines in each frame are not all the same with the actual vertical frequency, the actual vertical polarity, the actual horizontal frequency, the actual horizontal polarity, the actual total number of the horizontal lines in each frame.

7. The method according to claim 4, wherein the step of outputting the predetermined parameter to the digital display via the DDC from the computer further comprises:
determining whether the predetermined parameter is received by the digital display; and
continuing to output the predetermined parameter to the digital display from the computer via the DDC when the computer determines that the predetermined parameter is not received by the digital display.

8. The method according to claim 4, wherein the step of receiving and saving the predetermined parameter by the digital display further comprises:
labeling the predetermined parameter to be a newest flag parameter by the digital display when the predetermined parameter is received and saved by the digital display.

9. The method according to claim 8, wherein the step of determining the actual total number of the pixels in each horizontal line further comprises:
comparing the predetermined vertical frequency, the predetermined vertical polarity, the predetermined horizontal frequency, the predetermined horizontal polarity, the predetermined total number of the horizontal lines in each frame with the actual vertical frequency, the actual vertical polarity, the actual horizontal frequency, the actual horizontal polarity, the actual total number of the horizontal lines in each frame by the digital display to determine the actual total number of the pixels in each horizontal line when the newest flag parameter is saved in the digital display.

10. A method for determining a digital video signal of a digital display, wherein an extended display identification data (EDID) of the digital display is read by a computer via a display data channel (DDC) bus, the method comprises:
outputting at least a predetermined parameter to the digital display from the computer via the DDC bus when the computer detects that the resolution of the digital display is updated;
receiving and saving the predetermined parameter by the digital display;
outputting an analog video signal to the digital display from the computer;
receiving and saving the analog video signal by the digital display; and
determining the digital video signal from the analog video signal by the digital display according to the predetermined parameter.

11. The method according to claim 10, wherein the predetermined parameter comprises a predetermined vertical frequency, a predetermined vertical polarity, a predetermined horizontal frequency, a predetermined horizontal polarity, a predetermined total number of the horizontal lines in each frame, a predetermined total number of the pixels in each horizontal line, a predetermined total number of the display pixels in each horizontal line, a predetermined size of the horizontal front porch and a predetermined size of the horizontal back porch.

12. The method according to claim 11, wherein the step of determining the digital video signal from the analog video signal further comprises:
obtaining a clock sampling signal by the digital display according to the predetermined vertical frequency, the predetermined vertical polarity, the predetermined horizontal frequency, the predetermined horizontal polarity, the predetermined number of the horizontal lines in each frame and the predetermined number of the pixels in each horizontal line; and
sampling the analog video signal to obtain the digital video signal by the digital display according to the clock sampling signal, the predetermined number of the display pixels in each horizontal line, the predetermined horizontal front porch and the predetermined horizontal back porch.

13. The method according to claim 11, wherein the step of outputting the predetermined parameter to the digital display from the computer via the DDC bus further comprises:
determining whether the predetermined parameter is received by the digital display; and
continuing to output the predetermined parameter to the digital display from the computer via the DDC when the computer determines that the predetermined parameter is not received by the digital display.

14. A method for determining an actual total number of the pixels in each horizontal line of a digital display, wherein an EDID of the digital display is transmitted to the digital display by a display card of a computer via a DDC bus, the method comprises:
outputting at least a predetermined parameter to the digital display from the computer via the DDC bus when the computer detects that the resolution of the digital display is reset;
receiving and saving the predetermined parameter by the digital display;
outputting a horizontal synchronization signal and a vertical synchronization signal to the digital display from the computer;
receiving and saving the horizontal synchronization signal and the vertical synchronization signal by the digital display;
calculating at least one actual parameter by the digital display according to the horizontal synchronization signal and the vertical synchronization signal; and
determining the actual total number of the pixels in each horizontal line by the digital display according to the predetermined parameter and the actual parameter.

15. The method according to claim 14, wherein the predetermined parameter comprises a predetermined vertical frequency, a predetermined vertical polarity, a predetermined horizontal frequency, a predetermined horizontal polarity, a predetermined total number of the horizontal lines in each frame, and a predetermined total number of the pixels in each horizontal line.

16. The method according to claim 15, wherein the actual parameter comprises an actual vertical frequency, an actual vertical polarity, an actual horizontal frequency, an actual horizontal polarity and an actual total number of the horizontal lines in each frame.

17. The method according to claim 16, wherein the step of determining the actual total number of the pixels in each horizontal line further comprises:
comparing the predetermined vertical frequency, the predetermined vertical polarity, the predetermined horizontal frequency, the predetermined horizontal polarity, the predetermined total number of the horizontal lines in each frame with the actual vertical frequency, the actual vertical polarity, the actual horizontal frequency, the actual horizontal polarity, the actual total number of the horizontal lines in each frame by the digital display to determine the actual total number of the pixels in each horizontal line.

18. The method according to claim 17, wherein the step of determining the actual total number of the pixels in each horizontal line further comprises:
adopting the predetermined total number of the pixels in each horizontal line as the actual total number of the pixels in each horizontal line by the digital display when the predetermined vertical frequency, the predetermined vertical polarity, the predetermined horizontal frequency, the predetermined horizontal polarity, the predetermined total number of the horizontal lines in each frame are the same with the actual vertical frequency, the actual vertical polarity, the actual horizontal frequency, the actual horizontal polarity, the actual total number of the horizontal lines in each frame.

19. The method according to claim 17, the digital display having at least a timing table, wherein the step of determining the actual total number of the pixels in each horizontal line further comprises:
looking up at least one total number of the pixels in each horizontal line, which complies with or approximates the actual total number of the pixels in each horizontal line, from the timing table by the digital display according to the horizontal synchronization signal and the vertical synchronization signal when the predetermined vertical frequency, the predetermined vertical polarity, the predetermined horizontal frequency, the predetermined horizontal polarity, the predetermined total number of the horizontal lines in each frame are different from the actual vertical frequency, the actual vertical polarity, the actual horizontal frequency, the actual horizontal polarity, the actual total number of the horizontal lines in each frame.

20. The method according to claim 17, wherein the step of outputting the predetermined parameter to the digital display from the computer via the DDC bus further comprises:
determining whether the predetermined parameter is received by the digital display; and
continuing to output the predetermined parameter to the digital display from the computer via the DDC bus when the computer determines that the predetermined parameter is not received by the digital display.

21. The method according to claim 17, wherein the step of receiving and saving the predetermined parameter by the digital display further comprises:
labeling the predetermined parameter to be a newest flag parameter by the digital display when the predetermined parameter is received and saved by the digital display.

22. The method according to claim 21, wherein the step of determining the actual total number of the pixels in each horizontal line further comprises:
comparing the predetermined vertical frequency, the predetermined vertical polarity, the predetermined horizontal frequency, the predetermined horizontal polarity, the predetermined total number of the horizontal lines in each frame with the actual vertical frequency, the actual vertical polarity, the actual horizontal frequency, the actual horizontal polarity, the actual total number of the horizontal lines in each frame by the digital display to determine the actual total number of the pixels in each horizontal line when the newest flag parameter is saved in the digital display.
